(19) United States
(12) Patent Application Publication
(10) Pub. No.: US 2011/0296236 A1
(43) Pub. Date: Dec. 1, 2011

(54) Information Processing Apparatus

(76) Inventors: Yasuhiro Kawamoto, Tachikawa-shi (JP); Tsutomu Sonan, Hamura-shi (JP)

(21) Appl. No.: 13/100,828

(22) Filed: May 4, 2011

(30) Foreign Application Priority Data
May 28, 2010 (JP) 2010-123532

(51) Int. Cl. G06F 12/16; G06F 1/26; G06F 11/20

(52) U.S. Cl. 714/6.21; 711/114; 714/E11.098; 711/E12.103

(57) ABSTRACT

According to one embodiment, an information processing apparatus includes a board having an expansion slot, a RAID controller card inserted into the expansion slot, and a processor mounted on the board. The RAID controller card comprises a RAID controller configured to execute a write control and a read control in a first mode, the write control includes dispersing data, writing the dispersed data in first storage devices, calculating a parity of the dispersed data written in the storage devices, and writing the calculated parity in a second storage device, and the read control includes reading the dispersed data written in the first storage devices. The processor and is configured to execute the write control and the read control in a second mode, wherein the processor is configured to executes transfer of the dispersed data to the first storage devices and the second storage device via the RAID controller card.

### CROSS-REFERENCE TO RELATED APPLICATIONS

This application is based upon and claims the benefit of priority from Japanese Patent Application No. 2010-123532, filed May 28, 2010; the entire contents of which are incorporated herein by reference.

### FIELD

Embodiments described herein relate generally to an information processing apparatus comprising a RAID (Redundant Array of Inexpensive Disks) function.

### BACKGROUND

In the technical field of servers, RAID is often employed to make data redundant and store the data. If a fault occurs in a storage device constituting the RAID, the storage device in which the fault occurs may be replaced with a normal storage device.

Incidentally, processing such as parity calculation, management of the storage device, etc. relating to the RAID is generally executed by a RAID controller card inserted into an extension slot such as PCI (Peripheral Component Interconnect) -Express, etc.

If a fault occurs at the RAID controller card, the RAID controller card displays or records an error code corresponding to a location of the fault and its log, and urges an operation to be stopped at the occurrence of the fault.

In general, when the fault occurs at the RAID controller card, a maintenance person visits the location of the server and exchanges the RAID controller card. In this period, the RAID controller card is stopped, access to the storage device cannot be made, and a server cannot be used. In addition, since the storage device configured as the RAID, access to the storage device cannot be made by the other devices. It takes much time for the maintenance person to arrive at the location site of the server, and much time is wasted until the server is capable of being used.

Recently, reduction of power consumption has been required to suppress the emission of CO₂.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing an example of an outer appearance of a system configuration of a server device according to a first embodiment.

FIG. 2 is an exemplary perspective view showing an outer appearance of a main substrate and a RAID controller card according to the first embodiment.

FIG. 3 is an exemplary block diagram showing an example of a system configuration of the RAID controller card according to the first embodiment.

FIG. 4 is an exemplary flowchart showing an example of steps of processing in a case where a fault occurs at the RAID controller card according to the first embodiment.

FIG. 5 is an exemplary flowchart showing an example of steps of processing in a case where a fault occurs at the RAID controller card according to the first embodiment.

FIG. 6 is an exemplary block diagram showing a system configuration of an information processing apparatus according to a second embodiment.

FIG. 7 is an exemplary block diagram showing an example of a system configuration of the RAID controller card according to the second embodiment.

FIG. 8 is an exemplary flowchart showing an example of steps of processing for changing a hardware mode and a software mode according to the second embodiment.

FIG. 9 is an exemplary flowchart showing an example of steps of processing for changing the hardware mode and the software mode according to the second embodiment.

### DETAILED DESCRIPTION

Various embodiments will be explained hereinafter with reference to the accompanying drawings.

In general, according to one embodiment, an information processing apparatus includes a board, a RAID controller card, and a processor. The board has an expansion slot. The RAID controller card is inserted into the expansion slot, and comprises a RAID controller configured to execute a write control and a read control in a first mode, the write control comprising dispersing data, writing the dispersed data in first storage devices, calculating a parity of the dispersed data written in the storage devices, and writing the calculated parity in a second storage device, and the read control comprising reading the dispersed data written in the first storage devices. The processor is mounted on the board, and is configured to execute the write control and the read control in a second mode, wherein the processor is configured to execute transfer of the dispersed data to the first storage devices and the second storage device via the RAID controller card.

### First Embodiment

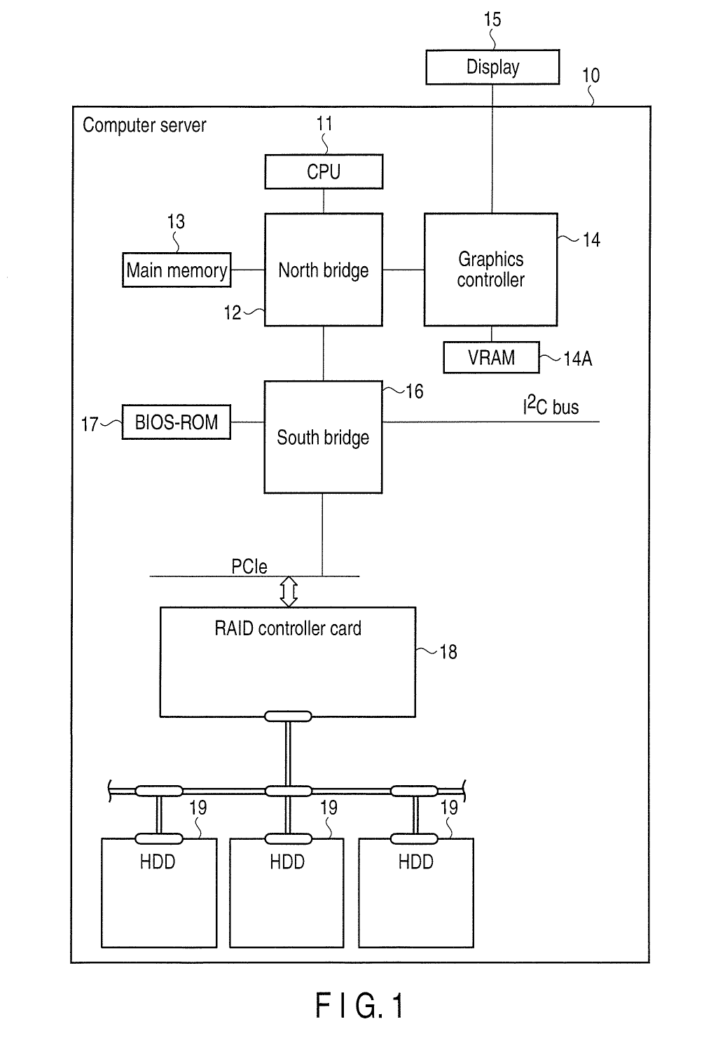

An information processing apparatus according to a first embodiment will be described with reference to FIG. 1. The information processing apparatus is implemented as a computer server.

FIG. 1 is a block diagram showing a system configuration of a computer server 10. The computer 10 comprises a CPU 11, a north bridge 12, a main memory 13, a graphics controller 14, a VRAM 14A, a south bridge 16, a BIOS-ROM 17, a RAID controller card 18, a hard disk drive (HDD) 19, etc. as shown in FIG. 1.

The CPU 11 is a processor which controls operations of each unit in the computer server 10. The CPU 11 executes an operating system loaded from the HDD 19 to the main memory 13 and various programs operated under control of the operating system. In addition, the CPU 11 also executes a basic input-output system (BIOS) stored in the BIOS-ROM 17. The basic input-output system stored in the BIOS-ROM 17 is often called BIOS in the following descriptions.

The north bridge 12 is a bridge device which makes connection between a local bus of the CPU 11 and the south bridge 16. The north bridge 12 has a function of executing communication with the graphics controller 14 via the bus. A memory controller which controls access to the main memory 13 is built in the north bridge 12. The graphics controller 14 is a display controller which controls a display 15. The graphics controller 14 generates an image signal to be transmitted to the display 15 from image data written in the VRAM 14A.

The south bridge 16 is a controller which controls various devices such as a PCI Express (PCIe) bus. In addition, the BIOS-ROM 17 is directly connected to the south bridge 16, and the south bridge 16 also has a function of controlling them.

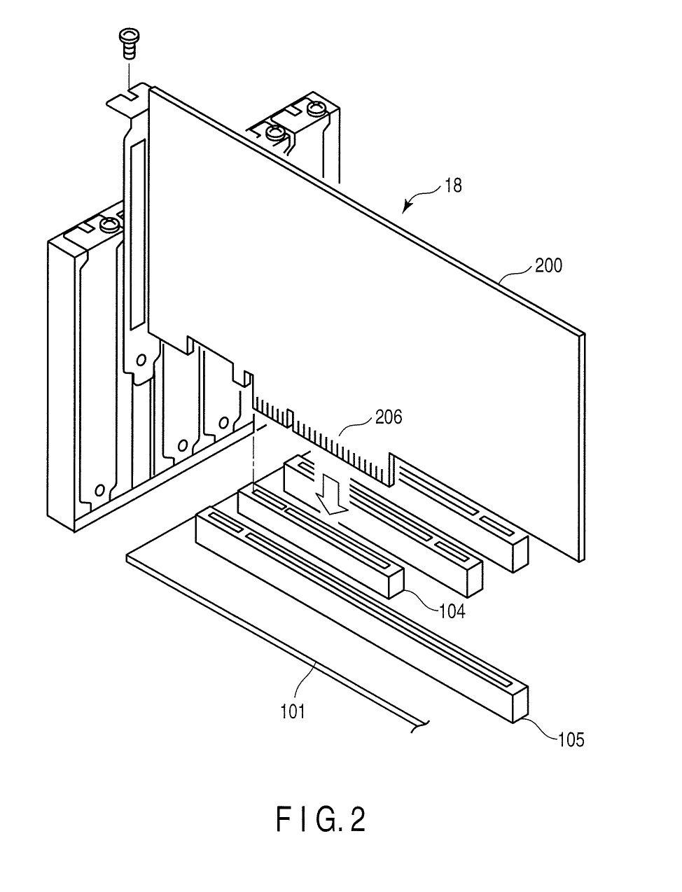

FIG. 2 is a perspective view showing a main substrate on which the CPU 11, the main memory 13, etc. are mounted, and the RAID controller card 18.

A plurality of expansion slots 104, 105 are provided on a main substrate 101 as shown in FIG. 2. The PCIe bus is connected to the expansion slots 104, 105. A PCI Express expansion card of less than 8 lanes can be inserted into the expansion slot 104. A PCI Express expansion card of less than 16 lanes can be inserted into the expansion slot 105. A connector unit 206 of an expansion substrate 200 constituting the RAID controller card 18 is inserted into the expansion slot 104 as shown in FIG. 2.

The computer server 10 is changed from a hardware mode which is a general operation mode, to a hardware safe mode or a software safe mode if a fault occurs at the RAID controller card 18. In general, when a fault occurs at the RAID controller card 18, the RAID controller card 18 stops its function and the computer server 10 does not work. The computer server 10 can continue working by changing the operation mode to the hardware safe mode or the software safe mode in the computer server 10.

In the hardware safe mode, a device causing the fault is stopped. In the software safe mode, write processing and read processing such as an operation of parity, etc. are executed by the CPU 11.

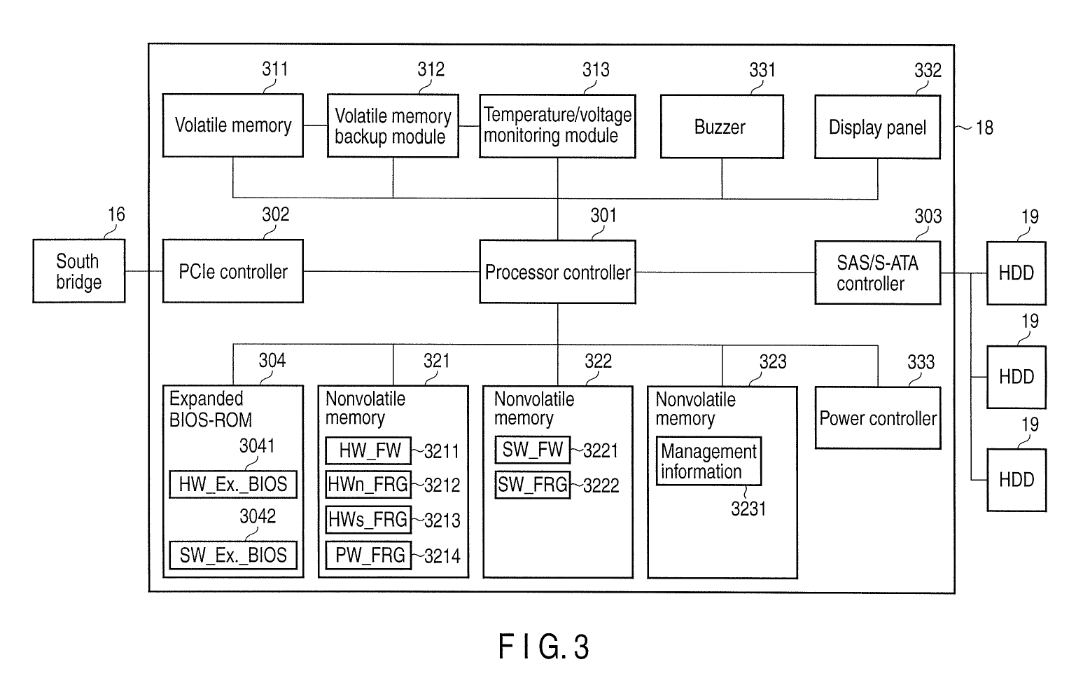

Next, a system configuration of the RAID controller card 18 is described with reference to FIG. 3. The RAID controller card 18 comprises a processor controller 301, a PCIe controller 302, a SAS/S-ATA controller 303, an expanded BIOS-ROM 304, a volatile memory 311, a nonvolatile memory backup module 312, a temperature/voltage monitoring module 313, a first nonvolatile memory 321, a second nonvolatile memory 322, a third nonvolatile memory 323, a buzzer 331, a display panel 332, a power controller 333, etc.

The processor controller 301 executes firmware 3211 stored in the nonvolatile memory 321 or firmware 3221 stored in the nonvolatile memory 322. In the hardware mode or the hardware safe mode, the processor controller 301 executes write control of dispersing and writing data in two HDD 19, operating parity of the data written in two hard disk drives 19, and writing the operated parity in one hard disk drive 19, and a read control of reading the data dispersed and written in two hard disk drives 19. In the software safe mode, the processor controller 301 controls transfer of the data between the CPU 11 and the HDD 19. A circuit for calculating the parity is provided in the processor controller 301. When the firmware 3211 is executed, the firmware 3211 is loaded in the volatile memory 311. When the firmware 3221 is executed, the firmware 3221 is loaded in a memory provided in the processor controller 301.

The PCIe controller 302 is a PCI Express interface for controlling the transfer of the data to/from the south bridge 16. The SAS/S-ATA controller 303 is an interface for controlling the transfer of the data to/from the HDD 19.

In the expanded BIOS-ROM 304, HW expanded BIOS (HW_Ex._BIOS) 304 loaded in the main memory 13 at the activation of the computer server 10 in the hardware mode and the hardware safe mode is stored. SW expanded BIOS (SW_Ex._BIOS) 3042 loaded in the main memory 13 at the activation of the computer server 10 in the software safe mode is also stored in the expanded BIOS-ROM 3041.

The backup module 312 comprises a battery, etc. for supplying electric power to the volatile memory 311 when a voltage value of the voltage supplied from the main substrate 101 is lowered. The temperature/voltage monitoring module 313 monitors temperature, voltage, etc. of the battery.

The volatile memory 311 is used to cache the data from a host. The volatile memory 311 is constituted by, for example, DDR2 SDRAM (Double-Data-Rate2 Synchronous Dynamic Random Access Memory).

In the first nonvolatile memory 321, firmware (HW_FW) 3211 for the hardware mode and the hardware safe mode is stored. In addition, a hardware mode flag (HWn_FRG) 3212 indicating whether the activation of the RAID controller card 18 is executed in the general hardware mode, a hardware safe mode flag (HWs_FRG) 3213 indicating whether the activation of the RAID controller card 18 is executed in the hardware safe mode, and a power supply flag (PW_FRG) 3214 indicating whether the electric power is supplied to the devices in the RAID controller card 18 such as the volatile memory 311, the backup module 312, the temperature/voltage monitoring module 313, etc. are provided in the first nonvolatile memory 321.

In the second nonvolatile memory 322, firmware 3221 for the software safe mode is stored. In addition, a software safe mode flag (SWn_FRG) 3222 indicating whether the activation of the RAID controller card 18 is executed in the software safe mode, is provided in the second nonvolatile memory 322.

In general, the firmware 3211 for the hardware mode and the hardware safe mode stored in the first nonvolatile memory 321 is executed. However, if a fault occurs at the controller card 18, the firmware 3221 for the software safe mode stored in the second nonvolatile memory 322 is executed.

Management information 3231 is stored in the third nonvolatile memory 323. The management information 3231 indicates construction information of the RAID array, information of the HDD 19 belonging to the RAID array, etc. The management information 3231 is also stored in each HDD 19.

The buzzer 331 is provided to generate an alarm when a fault occurs at the RAID controller card 18. In addition, the display panel 332 is provided to show an error code indicating a cause of a fault when the fault occurs.

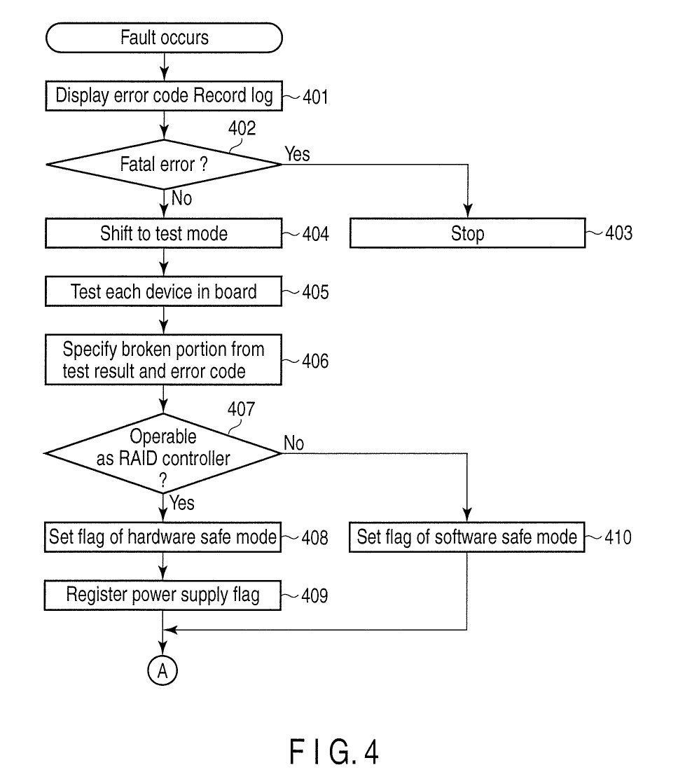

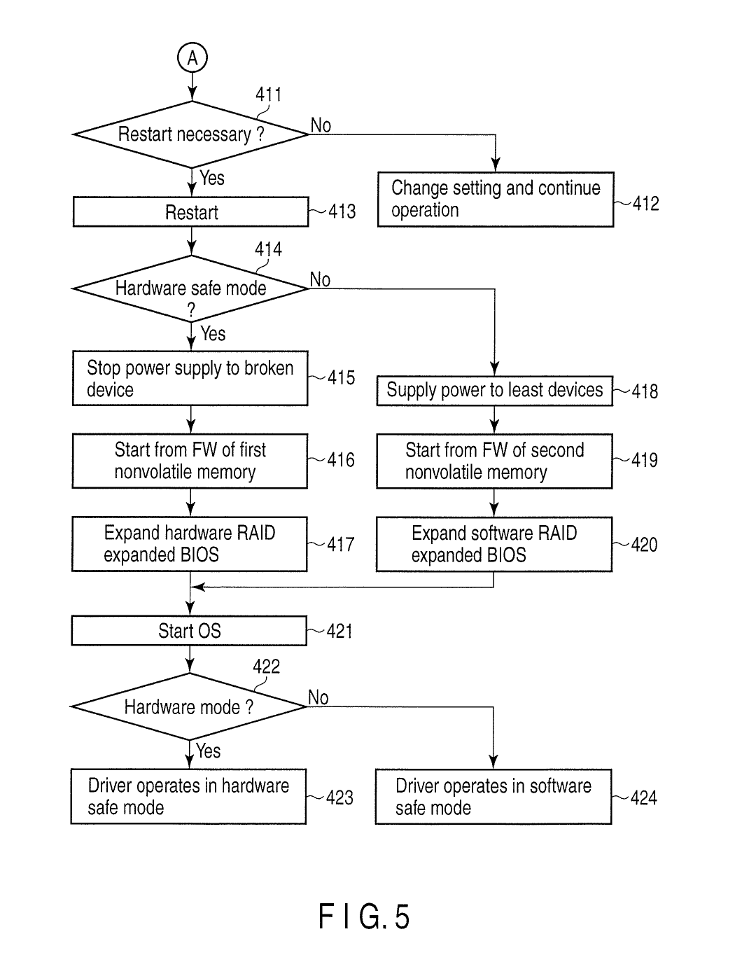

Next, steps of processing in a case where a fault occurs at the RAID controller card 18 will be explained with reference to flowcharts in FIGS. 4 and 5.

When a fault occurs at the RAID controller card 18, the processor controller 301 specifies a cause of the fault, displays an error code indicating the specified cause on the display panel 332, and records the specified cause in a log file (step 401). The log file is stored in the third nonvolatile memory 323.

The processor controller 301 discriminates whether the fault is a fatal fault or not, by referring to the log file (step 402).

If the fault is discriminated as a fatal fault (Yes in step 402), the processor controller 301 stops the RAID controller card 18 (step 403). If the fault is not discriminated as a fatal fault (No in step 402), the processor controller 301 shifts to a test mode (step 404).

The processor controller 301 tests each of the devices in the RAID controller card 18, and specifies a broken portion from the test result and the error code recorded in the log file (step 406).

The processor controller 301 discriminates whether the RAID controller card 18 is operable in the hardware safe mode even if the broken portion is not operated (step 407).

If the RAID controller card 18 is operable in the hardware safe mode (Yes in step 407), the processor controller 301 sets a value of the hardware mode flag 3212 in the first nonvolatile memory 321 to False, and sets a value of the hardware safe mode flag 3213 in the first nonvolatile memory 321 to True (step 408). Then, the processor controller 301 sets a value of the power supply flag 3214 of a device corresponding to the broken portion specified in step 406 to False (step 409).

If the RAID controller card 18 is not operable in the hardware safe mode (No in step 407), the processor controller 301 sets a value of the hardware mode flag 3212 in the first nonvolatile memory 321 to False, and sets a value of the hardware safe mode flag 3222 in the second nonvolatile memory 322 to True (step 410).

The processor controller 301 discriminates whether restart is necessary (step 411). If it is discriminated that restart is unnecessary (no in step 411), the processor controller 301 changes the settings and continues the operation (step 412). It is assumed that, for example, the temperature/voltage monitoring module 313 is broken. In this case, the backup module 312 cannot be operated. However, since the volatile memory 311 works, it can work in the hardware mode though the data write speed lowers. In this case, restart is unnecessary, the processor controller 301 sets a Write Back Cache function not to be used. In addition, the processor controller 301 stops supply of the power to the backup module 312 and the temperature/voltage monitoring module 313.

Then, a case where the volatile memory 311 is broken will be conceived. When the volatile memory is broken, the computer server cannot be activated in the hardware mode since the hardware test mode extends the firmware to the volatile memory 311 and operates by itself. In this case, the computer server is operated in the software mode. If the computer server is restarted after varying the value of the power supply flag 3214, it can be operated with the least hardware.

If the restart is necessary (Yes in step 411), it is executed (step 413). After the restart, the controller 301 reads the value of the hardware mode flag 3212. Since the of the hardware mode flag 3212 is False, the controller 301 reads the value of the hardware safe mode flag 3213. If the value of the hardware safe mode flag 3213 is True, the controller 301 reads the value of the power supply flag 3214 and instructs the power controller 333 to stop the supply of the power to the device in which the value of the power supply flag 3214 is False (step 415). The firmware stored in the first nonvolatile memory 321 is loaded on the memory 311 and the firmware is activated (step 416). The HW expanded BIOS 3041 for the hardware mode and the hardware safe mode is loaded on the main memory 13 (step 417). In addition, information indicating that the operation mode of the RAID controller card 18 is the hardware safe mode is recorded in a PCI configuration corresponding to the RAID controller card 18.

If the value of the hardware safe mode flag 3213 is False, the controller 301 reads the value of the software safe mode flag 3222. If the value of the software safe mode flag 3222 is True (No in step 414), the controller 301 instructs the power controller 333 to stop the supply of the power to a device other than the least necessary device for execution of the software safe mode (step 418). Then, the firmware 3221 stored in the second nonvolatile memory 322 is loaded on the memory in the controller 301, and is executed by the processor controller 301 (step 419). The SW expanded BIOS 3042 for the software mode is loaded on the main memory 13 (step 420). In addition, information indicating that the operation mode of the RAID controller card 18 is the software safe mode is recorded in the PCI configuration corresponding to the RAID controller card 18.

After that, the operating system is activated (step 421). The driver of the RAID controller card 18 obtains the operation mode of the RAID controller card 18 by referring to the PCI configuration corresponding to the RAID controller card 18.

If the operation mode of the RAID controller card 18 is the hardware safe mode (Yes in step 422), the driver of the RAID controller card 18 is operated in the hardware safe mode (step 423). If the operation mode of the RAID controller card 18 is the software safe mode (No in step 422), the driver of the RAID controller card 18 is operated in the software safe mode (step 424).

As described above, even if the fault occurs at the RAID controller card 18, the time at which the RAID controller card 18 cannot be used can be shortened as much as possible by operating it in the hardware safe mode or the software safe mode.

In addition, deterioration of the functions and the performance can be inhibited as much as possible by preparing three stages of the hardware mode, hardware safe mode and software mode and selecting the functions to be reduced due to the type of the broken device.

### Second Embodiment

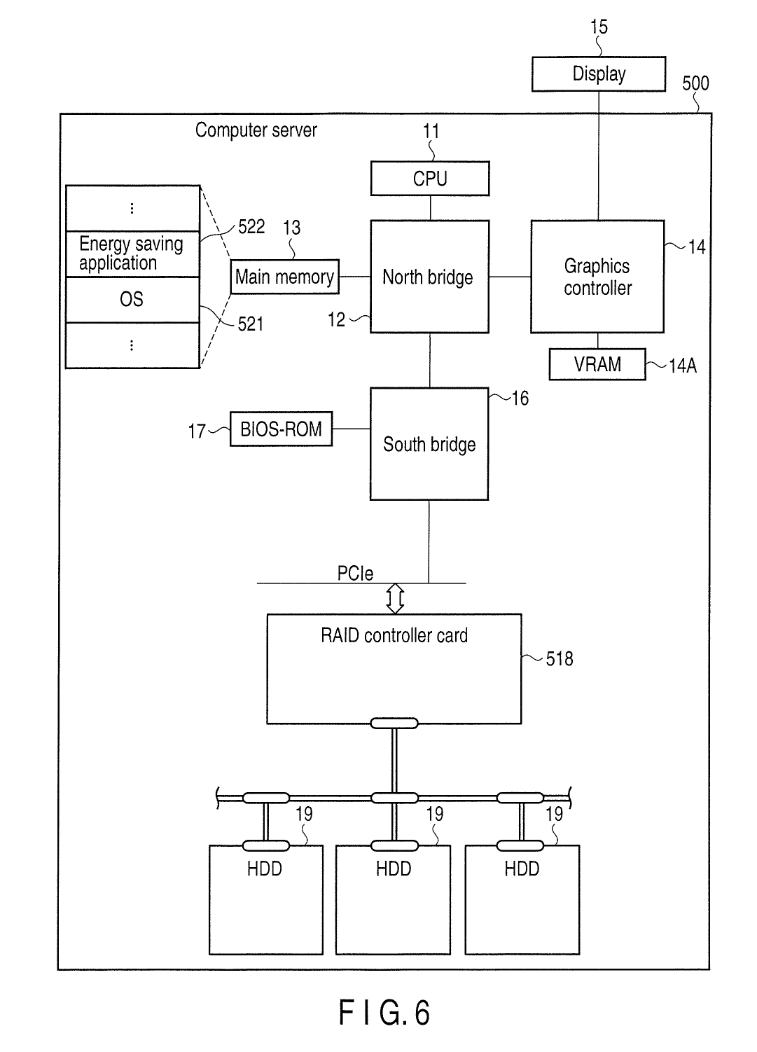

An information processing apparatus according to a second embodiment will be described with reference to FIG. 6. The information processing apparatus is implemented as a computer server.

FIG. 6 is a block diagram showing a system configuration of the information processing apparatus of the second embodiment. A computer server 500 comprises a CPU 11, a north bridge 12, a main memory 13, a graphics controller 14, a VRAM 14A, a south bridge 16, a BIOS-ROM 17, a RAID controller card 518, a hard disk drive (HDD) 19, etc. as shown in FIG. 6. The same units as those shown in FIG. 1 are denoted by the same reference numerals and their explanations are omitted.

The CPU 11 is a control device which totally controls various devices in the computer device 500. The CPU 11 executes an operating system 521, an energy saving application 522, etc. loaded on the main memory 13. The RAID controller card 518 executes RAID control of the HDD 19 connected to a plurality of interfaces.

The RAID controller card 518 and the computer server 500 according to this embodiment can be set at two operation modes. In a first mode (hardware mode), the RAID controller card 18 is operated in the general hardware mode. In a second mode (software mode), the software mode is dynamically changed to the software mode. The above-mentioned energy saving application 522 is an application program for changing the hardware mode and the software mode.

As for the dynamically changed modes, load of the RAID controller card 518 is automatically recorded in advance in a time axis, prediction information of a time band of small load is inferred based on the recorded information, a load status before and after the present time is confirmed, and the mode is changed.

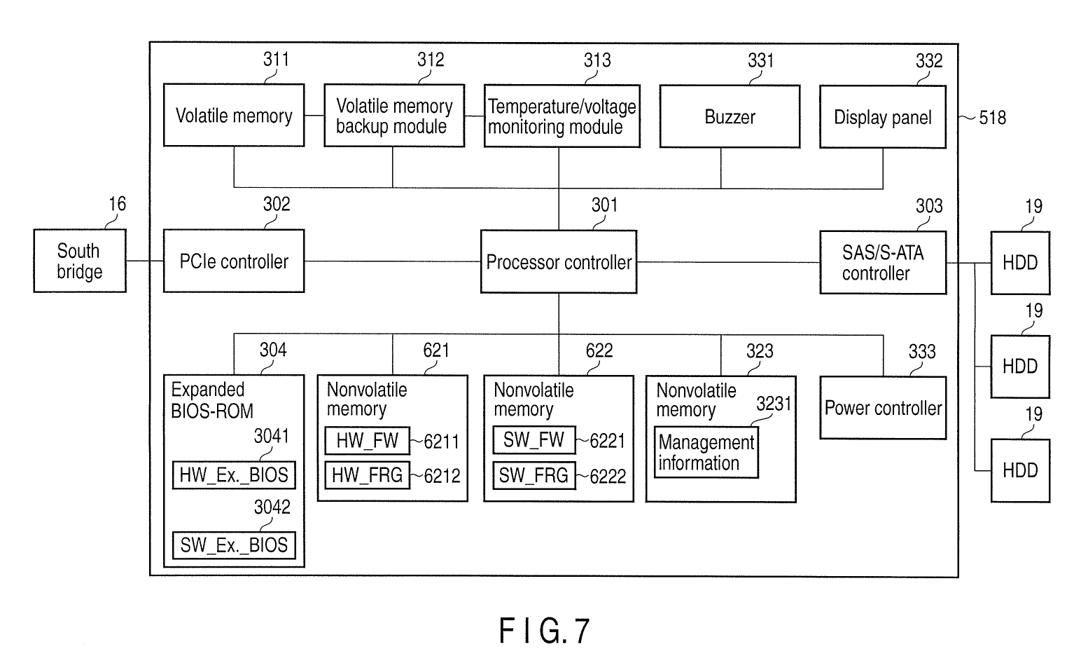

FIG. 7 is a block diagram showing a system configuration of the RAID controller card 518 according to the second embodiment.

The RAID controller card 518 comprises a processor controller 301, a PCIe controller 302, a SAS/S-ATA controller 303, an expanded BIOS-ROM 304, a volatile memory 311, a nonvolatile memory backup module 312, a temperature/voltage monitoring module 313, a first nonvolatile memory 621, a second nonvolatile memory 622, a third nonvolatile memory 323, a buzzer 331, a display panel 332, a power controller 333, etc. The same units as those shown in FIG. 3 are denoted by the same reference numerals and their explanations are omitted.

In the first nonvolatile memory 621, firmware (HW_FW) 6211 for the hardware mode is stored. A hardware mode flag (HWn_FRG) 6212 indicating whether the activation of the RAID controller card 518 is executed in the general hardware mode, is provided in the first nonvolatile memory 621.

In the second nonvolatile memory 622, firmware 6221 for the software safe mode is stored. A software safe mode flag (SWs_FRG) 6222 indicating whether the activation of the RAID controller card 518 is executed in the software safe mode, is provided in the second nonvolatile memory 622.

In general, the firmware 6211 for the hardware mode stored in the first nonvolatile memory 621 is executed. In the software mode, the firmware 6221 for the software safe mode stored in the second nonvolatile memory 622 is executed.

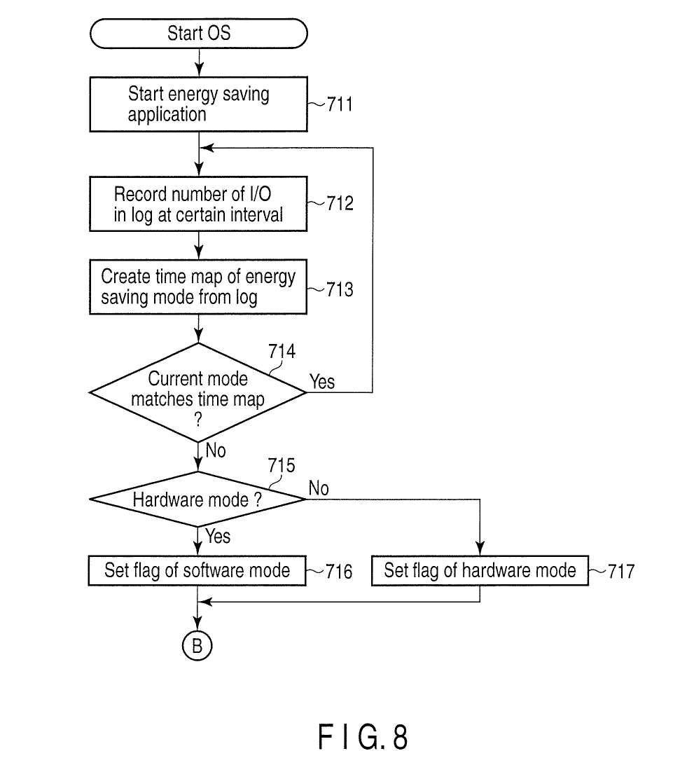

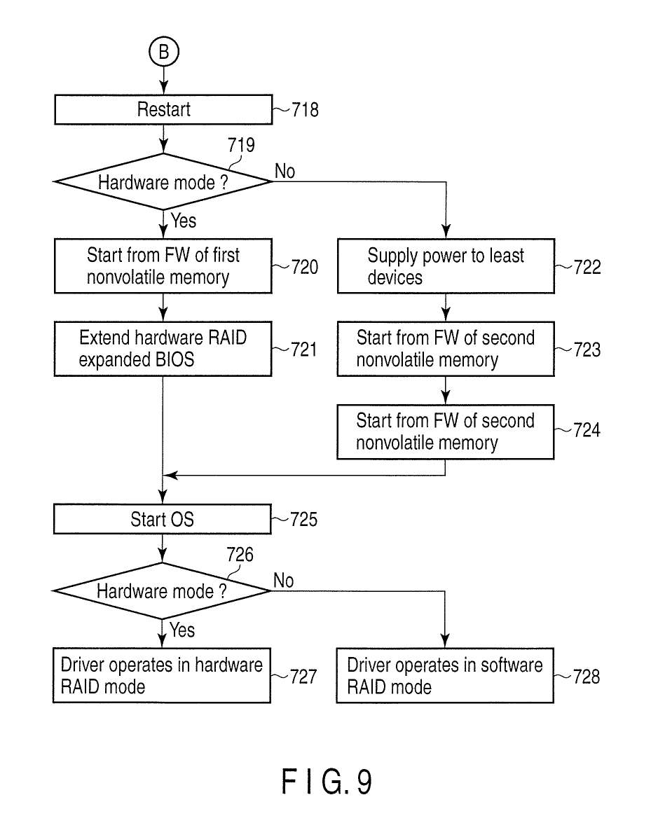

Next, steps of processing of changing the hardware mode and the software mode will be described with reference to flowcharts in FIG. 8 and FIG. 9.

First, after the activation of the operating system 521, the energy saving application 522 is activated (step 711). The energy saving application 522 records the number of I/O (Input/Output) of the hard disk drive 8 in a log file in a predetermined time interval (for example, 10 minutes) (step 712). The log file is stored in, for example, the HDD 19. The number of I/O of the processor controller 301 may be obtained instead of the number of I/O of the hard disk drive 8.

The energy saving application 522 creates a time table from the log file, statistically calculates a time zone in which access is made and its number of I/O, and creates a time map in which a predetermined time (for example, one hour) of the number of I/O continuing below a threshold value is set as a time of the software mode, and a time zone other than that in the software mode is set as a time zone in the hardware mode (step 713).

The energy saving application 522 discriminates whether the current operation mode matches the operation mode in the time map (step 714).

If the energy saving application 522 discriminates that the modes do not match (No in step 714), the energy saving application 522 discriminates whether the current operation mode is the hardware mode (step 715). If the current operation mode is discriminated as the hardware mode, the energy saving application 522 sets the value of the hardware mode flag 6212 to False and sets the value of the software mode flag 6222 to True (step 716). If the current operation mode is not discriminated as the hardware mode, the energy saving application 522 sets the value of the hardware mode flag 6212 to True and sets the value of the software mode flag 6222 to False (step 717).

The energy saving application 522 confirms that there has been no access in a period (for example, five minutes) before the current time, and then restarts the computer server 500 (step 718).

After the restart, the controller 301 reads the value of the hardware mode flag 6212. If the value of the hardware mode flag 6212 is True, the firmware 6211 stored in the first nonvolatile memory 621 is loaded on the memory 311 and the firmware 6211 is activated (step 720). The HW expanded BIOS 3041 for the hardware mode is loaded on the main memory 13 (step 721).

In addition, information indicating that the operation mode of the RAID controller card 18 is the hardware mode is recorded in a PCI configuration corresponding to the RAID controller card 18.

If the value of the hardware mode flag 6212 is False, the controller 301 reads the value of the software mode flag 6222. If the value of the software mode flag 6222 is True (No in step 719), the controller 301 instructs the power controller 333 to stop the supply of the power to a device other than the least necessary device for execution of the software mode (step 722). Then, the firmware 6221 stored in the second nonvolatile memory 622 is loaded on the memory in the controller 301, and is executed by the processor controller 301 (step 723). The SW expanded BIOS 3042 for the software mode is loaded on the main memory 13 (step 724). In addition, information indicating that the operation mode of the RAID controller card 18 is the software mode is recorded in the PCI configuration corresponding to the RAID controller card 18.

After that, the operating system is activated (step 725). The driver of the RAID controller card 518 obtains the operation mode of the RAID controller card 1 by referring to the PCI configuration corresponding to the RAID controller card 1.

If the operation mode of the RAID controller card 1 is the hardware safe mode (Yes in step 726), the driver of the RAID controller card 518 is operated in the hardware mode (step 727). If the operation mode of the RAID controller card 518 is the software mode (No in step 726), the driver of the RAID controller card 518 is operated in the software mode (step 728).

Power consumption can be reduced by setting operation mode to the software mode at the time zone at which there are a small number of I/O to/from the HDD 19.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a board having an expansion slot;
a RAID controller card inserted into the expansion slot, comprising a RAID controller configured to execute a write control and a read control in a first mode, the write control comprising dispersing data, writing the dispersed data in first storage devices, calculating a parity of the dispersed data written in the storage devices, and writing the calculated parity in a second storage device, and the read control comprising reading the dispersed data written in the first storage devices; and
a processor mounted on the board, configured to execute the write control and the read control in a second mode, wherein the processor is configured to execute transfer of the dispersed data to the first storage devices and the second storage device via the RAID controller card.

2. The apparatus of claim 1, wherein the RAID controller card further comprises a power controller which selectively supplies devices in the RAID controller card with an electric power necessary to execute the transfer of the dispersed data between the first storage devices and the second storage device, and the processor, in the second mode.

3. The apparatus of claim 1, wherein the first mode is a mode in which an no fault occurs at the RAID controller card; and
the second mode is a mode in which a fault occurs at the RAID controller card.

4. The apparatus of claim 3, wherein the RAID controller is configured to execute the write control and the read control when the fault allows the write control to be executed.

5. The apparatus of claim 3, further comprising a power controller configured to stop supply of an electric power to a device wherein the fault is occurred.

6. The apparatus of claim 1, further comprising switching module configured to obtain number of I/O at first storage devices and the second storage device at each equal time interval, and to switch the first mode and the second mode in accordance with the obtained number of I/O.

7. A RAID controller card inserted into an expansion slot of a board, the card comprising:
a controller,
the controller configured to execute a write control and a read control in a first mode, the write control comprising dispersing data, writing the dispersed data in first storage devices, calculating a parity of the dispersed data written in the storage devices, and writing the calculated parity in a second storage device, and the read control comprising reading the dispersed data written in the first storage devices, and
the controller is configured to control of controlling transfer of data between a processor mounted on the board to execute the write control and the read control by executing communication with the RAID controller card, and the first storage devices and the second storage device, in a second mode.

8. The RAID controller card of claim 7, wherein the RAID controller card further comprises a power controller which selectively supplies devices in the RAID controller card with an electric power necessary to execute the transfer of the dispersed data between the first storage devices and the second storage device, and the processor, in the second mode.

9. The RAID controller card of claim 7, wherein the first mode is a mode in which an no fault occurs at the RAID controller card; and
the second mode is a mode in which a fault occurs at the RAID controller card.

10. The apparatus of claim 9, wherein the RAID controller is configured to execute the write control and the read control when the fault allows the write control to be executed.

11. The RAID controller card of claim 9, further comprising a power controller configured to stop supply of an electric power to a device wherein the fault is occurred.

12. A method of controlling an information processing apparatus, the apparatus comprising a board, the board comprising an expansion slot, a RAID controller card inserted into the expansion slot having a RAID controller, and a processor mounted on the board, the method comprising:
executing, by the RAID controller, a write control and a read control in a first mode, the write control comprising dispersing data, writing the dispersed data in first storage devices, calculating the dispersed data written in the first storage devices, and writing the calculated parity in a second storage device, and the read control comprising reading the dispersed data written in the first storage devices; and
executing the write control and the read control by the processor in a second mode, wherein the processor is configured to execute transfer of the dispersed data with the first storage devices and the second storage device via the RAID controller card.

13. The method of claim 12, further comprising:
selectively supplying devices in the RAID controller card with an electric power necessary to execute the transfer of the dispersed data between the first storage devices and the second storage device, and the processor, in the second mode.

14. The method of claim 12, wherein the first mode is a mode in which an no fault occurs at the RAID controller card; and
the second mode is a mode in which a fault occurs at the RAID controller card.

15. The method of claim 14, further comprising:
executing, by the RAID controller, the write control and the read control when the fault allows the write control to be executed.

16. The method of claim 14, further comprising:
stopping supply of an electric power to a device wherein the fault is occurred.

17. The method of claim 12, further comprising:
obtaining number of I/O at first storage devices and the second storage device at each equal time interval;
switching the first mode and the second mode in accordance with the obtained number of I/O.
